(19) United States
(12) Patent Application Publication
(10) Pub. No.: US 2008/0052629 A1
(43) Pub. Date: Feb. 28, 2008

(54) METHODS AND SYSTEMS FOR MONITORING TIME ON A WEB SITE AND DETECTING CLICK VALIDITY

(75) Inventors: David Phillips, Leawood, KS (US); Scott Lynn, Kansas City, MO (US); Shane Brady, Stilwell, KS (US)

Correspondence Address: LATHROP & GAGE LC, 2345 GRAND AVENUE, SUITE 2800, KANSAS CITY, MO, 64108, US

(73) Assignee: ADKNOWLEDGE, INC., Kansas City, MO (US)

(21) Appl. No.: 11/844,983

(22) Filed: Aug. 24, 2007

Related U.S. Application Data
(60) Provisional application No. 60/840,593, filed on Aug. 26, 2006.

(51) Int. Cl. G06F 15/177; G06F 3/00; G06Q 99/00

(52) U.S. Cl. 715/736; 705/1; 715/760

(57) ABSTRACT

Systems and methods are disclosed for monitoring the time a user spends on a web site. This data as to the time spent on the web site may be used to determine the validity of the click that caused the user's browsing application to be directed to this web site. Systems and methods are also disclosed for detecting fraudulent clicks based on the location of web browser windows.

### CROSS-REFERENCES TO RELATED APPLICATIONS

This application is related to and claims priority from commonly owned U.S. Provisional Patent Application Ser. No. 60/840,593, entitled: Method System and Process for Tracking The Time Spent on a Web Site Following an Input, filed Aug. 26, 2006, this Provisional Patent Application incorporated by reference herein.

### TECHNICAL FIELD

The present disclosed subject matter is directed to ascertaining the validity of consumer interests over networks, such as the Internet, and in particular, to tracking the amount of time a consumer spends on a particular web site.

### BACKGROUND

Advertising over and through the wide area and public networks, for example, the Internet, takes various forms. Advertisements may be delivered via electronic mail and also displayed on Internet Web pages. Advertisers are interested in maximizing the return on the advertising dollars they spend, by displaying their promotions to the most qualified consumer leads possible.

The interactive nature of the Internet permits advertisers to learn valuable information about consumer preferences and interests through the use of technology. With currently available technology, an advertiser can generally tell exactly how many users visited a particular Web page over a period of time; how many of those users clicked on the advertiser's promotion on a particular Web page; and through its internal record-keeping it may determine how many purchases were made through its own Web page in the same or similar time period as a result of the advertising. Where the advertisement is transmitted through an electronic communication, such as an electronic mail (e-mail), current technology permits an advertiser to be able to monitor how many mails were sent, to which email addresses they were sent, which of the e-mails were opened by recipients, and how many recipients clicked on the promotion, so that their browsing applications may be redirected to the advertiser's Web site. Generally, advertisers are willing to pay for access to this type of information.

### SUMMARY

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen (monitor) or computer screen display, for example, an activatable portion or link, that causes an action of the various software and or hardware supporting the computer screen display.

A banner is a graphic that appears on the monitor or screen (“monitor” and “screen” of a computer used interchangeably herein) of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, that is accessible on the Internet.

A server is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as they are placed into the creative, at the time the creative is activated, which may be upon the opening of an electronic communication, or e-mail with the creative. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipients browsing application or browser to be directed to the target web site corresponding to the activated link.

Pay Per Click (PPC), also known as price per click and cost per click, as used herein, is the amount of money that an advertiser, web site promoter, or other party who owns or is associated with a web site, will pay to a system administrator for providing their advertisement, listing, link or the like to a user, and the user clicks their mouse or pointing device on the advertisement, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence of servers, databases, caches, components, listings, links, data files, etc.

“Click-through” or “click-throughs” are industry standard terms for a user clicking on a link in an electronic object, such as an e-mail, creative, banner, listing on a web site, for example, a web site of a search engine, or the like, and ultimately having their browser directed to the targeted data object, typically a web site, associated with the link.

The present disclosed subject matter provides advertisers, advertisement networks, website promoters and entities associated therewith, brokers, advertising agencies, application service providers or others (collectively “Promoters”) displaying promotions over the Internet through banners, e-mail and other distribution channels valuable information about consumer behavior. In particular, the disclosed subject matter permits a promoter to determine how much time a consumer (also known as a user) spends on the Web site of the promoter or any third party after that consumer activates or clicks on an online advertisement. The disclosed subject matter is, for example, accomplished through a monitoring entity, without any cooperation from the third party web site, and without any need for the promoter to have any communication with the third party web site. The ability to monitor time spent by a consumer on a web site permits the advertiser to assess the economic value of that visit to the web site and to vary the amount it pays for the display of, or the click on (activation by a mouse or other similar pointing device), a particular promotional offer. Additionally, by analyzing the time spent on a web site and/or the location and/or size of the web browser window relative to the user's computer screen or monitor, the validity of the click or activation that resulted in the browser being directed to the target web site can be determined, allowing clicks to be found fraudulent or invalid, and not credited for payment while other clicks are valid and suitable for payment.

The present disclosed subject matter is related to systems and methods for activating a portion of an electronic communication, provided by a monitoring entity or an entity associated with the monitoring entity, to arrive at a target web site or web page (collectively “web site”, made up of web pages) by the browsing application of the requisite user being directed to this target web site or web page. Once the content is activated, and the user's browsing application is redirected to the target web site or web page, the time that user spends on this web site or web page is monitored or tracked by the monitoring entity.

An embodiment of the disclosed subject matter is directed to a method for monitoring the time a user spends on a web site. The method includes sending a document to the browsing application associated with a user who has activated the browsing application to be directed to a target web site and recording the time the document is sent. A web page is then received in the browsing application for overlying the document, the web page corresponding to the target web site. The document is closed in response to a closing event of the web site in the browsing application, and the time the document was closed is recorded.

The document is, for example, an HTML coded document. A closing event may be, for example, closing of the web page being viewed, a renavigation to a new URL, different that the URL of the web page of the web site presently being viewed, a hot key activation or any other known method for moving to a web site with a different that the URL of the web page of the web site presently being viewed.

Another embodiment of the disclosed subject matter is directed to a method for determining the validity of a click. The method includes receiving an indication of a click on an electronic object. The electronic object may be, for example, creative, banner, e-mail with a footer or tag line, or other electronic communication, or a web site or web page, all of these electronic objects linked in some way to the server or device associated with determining the validity of the click. A document, for example, an HTML coded document, is sent to the browsing application associated with a user who has activated the browsing application to be directed to a target web site. The time the document is sent is recorded and a web page corresponding to the target web site in the browsing application for overlying the document is received. The document is closed in response to a closing event of the web site in the browsing application. The closing event may be, for example, closing of the web page being viewed or a renavigation to a new URL, different that the URL of the web page of the web site presently being viewed. The time the document was closed is recorded and it is determined from the recorded times if the click is valid. For example, in a pay per click (PPC) scenario, if the click is valid, the promoter pays the party responsible for providing the click-through URL to the promoter's target web site for the click. Conversely, if the click is not valid (invalid) or fraudulent, this payment is not made.

Another embodiment is directed to a system for monitoring the time a user spends on a web site. The system includes a component for providing a document and a processor. The component for providing the document may be, for example, a storage device that holds the document or data corresponding thereto, or a component for generating the document. The document is, for example, an HTML coded document. The processor is programmed to: send a document to the browsing application associated with a user who has activated the browsing application to be directed to a target web site, record the time the document is sent, and receive a web page corresponding to the target web site in the browsing application for overlying the document. The program continues as the document is closed in response to a closing event of the web site in the browsing application, and the time the document was closed is recorded.

Another embodiment is directed to a system for determining the validity of a click. The system includes a component for providing a document and a processor. The component for providing the document may be, for example, a storage device that holds the document or data corresponding thereto, or a component for generating the document. The document is, for example, an HTML coded document. The processor is programmed to: receive an indication of a click on an electronic object, send a document to the browsing application associated with a user who has activated the browsing application to be directed to a target web site, record the time the document is sent, receive a web page corresponding to the target web site in the browsing application for overlying the document, close the document in response to a closing event of the web site in the browsing application, record the time the document was closed, and determine from the recorded times if the click is valid.

Another embodiment is directed to a computer-usable storage medium. The computer-usable storage medium has a computer program embodied thereon for causing a suitably programmed system to monitor the time a user spends on a web site, by performing the following steps when such program is executed on the system. These steps include: sending a document to the browsing application associated with a user who has activated the browsing application to be directed to a target web site, recording the time the document is sent, receiving a web page corresponding to the target web site in the browsing application for overlying the document, closing the document in response to a closing event of the web site in the browsing application, and recording the time the document was closed.

Another embodiment is directed to a computer-usable storage medium. The computer-usable storage medium has a computer program embodied thereon for causing a suitably programmed system to determine the validity of a click, by performing the following steps when such program is executed on the system. These steps include: receiving an indication of a click on an electronic object, sending a document to the browsing application associated with a user who has activated the browsing application to be directed to a target web site, recording the time the document is sent, receiving a web page corresponding to the target web site in the browsing application for overlying the document, closing the document in response to a closing event of the web site in the browsing application, recording the time the document was closed, and, determining from the recorded times if the click is valid.

Another embodiment of the disclosed subject matter is directed to a method for determining the validity of a click. The method includes receiving an indication of a click on an activatable location of an electronic object, and determining if the location of the web browser window that supported the activatable location is visible on the screen of the user associated with the click. If the location of the web browser window that supported the activatable location is visible on the screen of the user associated with the click, it is determined if the web browser window is at least a predetermined size.

Another embodiment of the disclosed subject matter is directed to a system for determining the validity of a click. The system includes three components. The first component is for receiving an indication of a click on an activatable location of an electronic object. The second component is for determining if the location of the web browser window that supported the activatable location is visible on the screen of the user associated with the click. The third component is for determining if the web browser window is at least a predetermined size.

Another embodiment is directed to a computer-usable storage medium. The computer-usable storage medium has a computer program embodied thereon for causing a suitably programmed system to determine the validity of a click, by performing the following steps when such program is executed on the system. These steps include: receiving an indication of a click on an activatable location of an electronic object; and determining if the location of the web browser window that supported the activatable location is visible on the screen of the user associated with the click. If it is determined that the location of the web browser window that supported the activatable location is visible on the screen of the user associated with the click, there is the additional step of determining if the web browser window is at least a predetermined size.

### BRIEF DESCRIPTION OF THE DRAWINGS

Attention is now directed to the drawing figures, where like or corresponding numerals or characters indicate corresponding or like components. In the drawings:

FIG. 1 is a diagram of an exemplary system supporting the disclosed subject matter;

FIG. 2 is a flow diagram (flow chart) detailing an exemplary process performed in accordance with the disclosed subject matter;

FIG. 3A is a diagram of the exemplary system of FIG. 1 performing part of the operation of the flow chart of FIG. 2;

FIGS. 3B-3D are exemplary electronic communications (electronic objects) for the process of the disclosed subject matter;

FIGS. 4-6 are diagrams of the exemplary system of FIG. 1 performing part of the operation of the flow chart of FIG. 2;

FIG. 7A is a diagram of the exemplary system of FIG. 1 performing part of the operation of the flow chart of FIG. 2;

FIG. 7B is a screen diagram of the web page that overlies an HTML document in accordance with the diagram of FIG. 7A;

FIGS. 8A and 8B are diagrams of a closing event in accordance with the process of the flow chart of FIG. 2;

FIG. 9 is a diagram of an alternate closing event in accordance with the process of the flow chart of FIG. 2; and,

FIG. 10 is a screen diagram the web page of FIG. 9.

Appendix A (nine pages), from HTML 4.01 Specification-W3C Recommendation 24 Dec. 1999, Part 16 Frames, Sections 16.1 and 16.2, available at http://www.w3.org/TR/html401/present/frames.html, is attached to this document.

Throughout this document, numerous textual and graphical references are made to trademarks. These trademarks are the property of their respective owners, and are referenced only for explanation purposes herein.

### DETAILED DESCRIPTION OF THE DRAWINGS

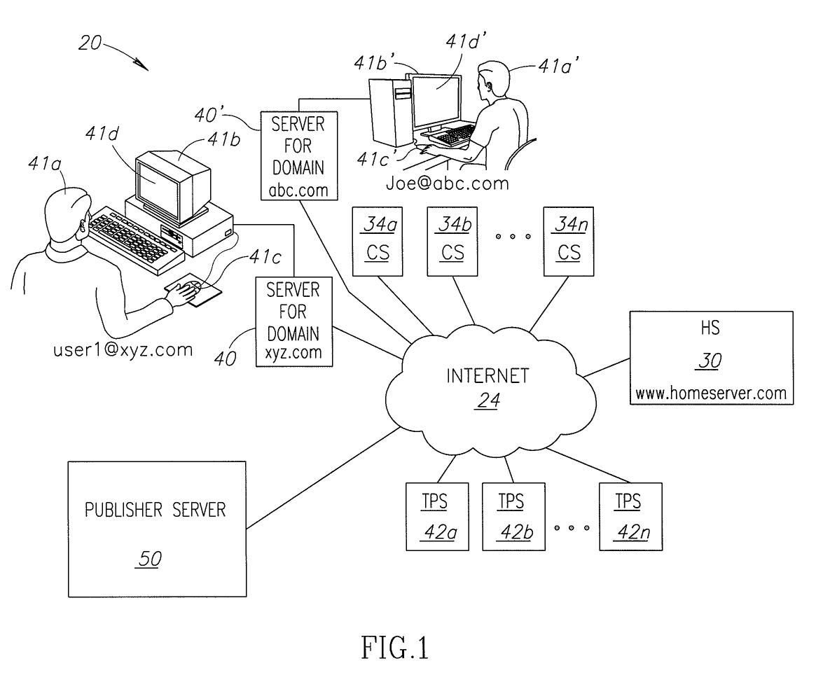

FIG. 1 shows the present disclosed subject matter in an exemplary operation. The present disclosed subject matter employs a system 20, formed of various servers and server components, that are linked to a network, such as a wide area network (WAN), that may be, for example, the Internet 24.

There are, for example, numerous servers that form the system 20. These servers, for example, include a home server (HS) 30 and one or more content servers (CS) 34a-34n. These servers 30 and 34a-34n are linked to the Internet 24, so as to be in electronic communication with each other. The servers 30, and 34a-34n include multiple components for performing the requisite functions as detailed below, and the components are based in hardware, software, or combinations thereof. The servers 30 and 34a-34n may also have internal storage media and/or be associated with external storage media.

The servers 30 and 34a-34n of the system 20 are linked (either directly or indirectly) to an endless number of other servers and the like, via the Internet 24. Other servers, exemplary for describing the operation of the system 20, include domain servers 40, 40′ for the domain (for example, the domains “xyz.com” and “abc.com” respectively) of the respective users 41a, 41a′ (for example, whose e-mail address are user1@xyz.com and joe@abc.com, respectively), linked to the computers 41b, 41b′ of the users 41a, 41a′. The users 41a, 41a′ are exemplary of all users of the system 20.

For example, each intended recipient or user 41a, 41a′, exemplary of all users/intended recipients, has a computer 41b, 41b′ (such as a multimedia personal computer with a Pentium® CPU, that employs a Windows® operating system), that uses an e-mail client. The computers 41b, 41b′ are linked to the Internet 24. The computers 41b, 41b′ may also be operated by an activatable pointer, such as a mouse 41c, 41c′ or the like, and include a monitor or screen 41d, 41d′ (“monitor” and “screen” of a computer used interchangeably herein). The user 41a may have an e-mail address, for example, of user1@xyz.com, while the user 41a′ may have an e-mail address, for example, joe@abc.com.

Initially, the computer 41b, 41b′ of the respective user 41a, 41a′ includes an e-mail client (detailed above), installed thereon, that provides the user with a unique address and the ability to utilize one or more e-mail addresses. For example, the user 41a has an e-mail address, user1@xyz.com, through which he receives his e-mail from the domain server 40, that hosts the domain xyz.com, of which the user 41a is a member. The computers 41b, 41b′ also include a web browser, browsing software, application, or the like, to access web sites or web pages from various servers and the like, on the Internet 24. Some exemplary web browsers/web browsing software include, Internet Explorer®, from Microsoft, Redmond, Wash., and Netscape® Navigator®.

Still other servers may include third party servers (TPS) 42a-42n. These servers are, for example, controlled by web site promoters, including publishers, content providers, or other entitles, that may or may not be related to any of the entities detailed above, in particular, the entity associated with the home server (HS) 30 and/or any of the content servers 34a-34n.

There may also be one or more publisher servers, represented by the publisher server 50. These publisher servers (represented by publisher server 50) are, for example, associated with a third party, and receive data for electronic communications from the home server (HS) 30 and sends it to an intended recipient, such as one or more of the users 40a, 40a′. The publisher server 50 is typically controlled by an entity separate from, and unrelated to, the entity that controls the home server (HS) 30 and/or any of the content servers 34a-34n.

While various servers have been listed, this is exemplary only, as the present disclosed subject matter can be performed on an endless numbers of servers and associated components, that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The home server (HS) 30 is of an architecture that includes one or more components, modules and the like, for providing numerous additional server functions and operations, for example, comparison and matching functions, policy and/or rules processing, various search and other operational engines, browser directing and redirecting functions, and the like. The home server (HS) 30 includes various processors, including microprocessors, for performing the server functions and operations detailed herein, including those for generating and supporting HTML documents and its associated data, such as java script and the like, for monitoring time on a web site or web page as well as hardware and software for analyzing the recorded time, as well as for detecting invalid or fraudulent clicks based on their positioning inside browser windows.

The home server (HS) 30 may be such that it sends or provides electronic communication as an e-mail that was opened to generate a creative, a portion of which the user activated to reach the target web site or web page, this home server (HS) 30 as disclosed in U.S. Patent Application Publication No. 2005/0038861 A1 (Published U.S. patent application Ser. No. 10/915,975, filed Aug. 11, 2004), entitled: Method And System For Dynamically Generating Electronic Communications, this document and the disclosure of which is incorporated by reference herein.

The home server (HS) 30 may also be such that it provides electronic data for a creative to a mail transfer agent (MTA) of a publisher server 50 that places the electronic data into an e-mail, that when opened generates the requisite creative. Once the creative is activated by a mouse click or the like, the user is directed to the target web site. This home server (HS) 30 is in accordance with commonly owned U.S. patent application Ser. No. 11/774,106, entitled: Method And System For Providing Electronic Communications With Dynamically Provided Content To Third Party Mail Transfer Agents, filed Jul. 6, 2007, this application and the disclosure of which is incorporated by reference herein.

The home server (HS) 30 may also be such that it provides electronic data for a tag line or footer to a publisher server 50, that functions as a backbone server, that places the tag line or footer into an e-mail, sent between parties or users 41a, 41a′, such as user1@xyz.com to joe@abc.com. When the e-mail is opened by the recipient, the tag line or footer appears, that when activated or clicked on, the user is directed to the target web site. This home server (HS) 30 is in accordance with U.S. patent application Ser. No. 11/774,106, entitled: Method And System For Providing Electronic Communications With Dynamically Provided Content To Third Party Mail Transfer Agents, listed above.

The home server (HS) 30 may be such that it sends e-mails or banners directly to the user, over web pages and the like that they are viewing. The banners are such that when activated or clicked on direct the user's browsing application to a target web site or web page, as disclosed in U.S. Patent Application Publication No. 2006/0212349 A1 (Published U.S. patent application Ser. No. 11/361,480), entitled: Method And System For Delivering Targeted Banner Electronic Communications, filed Feb. 24, 2006, this document and the disclosure of which is incorporated by reference herein.

The home server (HS) 30 may also include storage media, devices, etc, either internal or associated therewith. This storage media may store documents and/or data corresponding to these documents, such as hypertext markup language (HTML) coded documents (and/or data corresponding thereto), that are sent by the home server (HS) 30 (for example, as HTML coded documents), detailed below. By “home server”, it is meant all servers and components necessary to support the home server (HS) 30 in the requisite function, such as imaging servers, as disclosed in U.S. patent application Ser. Nos. 10/915,975, 11/361,480 and 11/774,106, e-mail API servers, and tag servers, as disclosed in U.S. patent application Ser. No. 11/774,106, and caches, databases and the like, as disclosed in U.S. patent application Ser. Nos. 10/915,975, 11/361,480 and 11/774,106. For explanation purposes, the home server (HS) 30 has a uniform resource locator (URL) of, for example, www.homeserver.com.

Content servers (CS) 34a-34n (one or more) are also linked to the Internet 24. The content servers (CS) 34a-34n provide content to the intended recipient, typically through the home server (HS) 30 (for example, as data, code or the like from an image link returned to the home server (HS) 30, as detailed below), and, for example, in response to a request from the home server (HS) 30, as detailed below. These content servers (CS) 34a-34n may be, for example, Pay-Per-Click (PPC) servers of various content providers, such as internal providers, or external providers, for example, Overture Services, Inc. or Findwhat, Inc.

The publisher server 50 includes various processors, including microprocessors, for performing the aforementioned server functions and operations and storage media, either internal or associated therewith, as well as other server operations. The publisher server 50 need not be present in the system 20 when the home server (HS) 30, for example, is sending e-mail communications directly to users or providing banners and the like to various web sites and web pages, supported, for example, by the third party servers (TPS) 42a-42n. By “publisher server” here, it is meant all servers and components necessary to support the publisher server 50, such as proxy servers, caches, databases, etc., in the requisite function.

The publisher server 50 is part of the system 20 when the system 20 includes a server that functions as a mail transfer agent, typically with a mail transfer agent module therein or peripheral thereto, with content received from the home server (HS), as disclosed in U.S. patent application Ser. No. 11/774,106. The publisher server 50 and the mail transfer agent module are configurable to work with numerous types of e-mail clients, associated with various intended recipients (users), such as America Online® (AOL®), Eudora®, Outlook®, and other web-based clients. Also, when functioning as a mail transfer agent the publisher server 50 typically includes a proxy server, such as that disclosed in U.S. patent application Ser. No. 11/774,106. Similarly, in this situation, the home server (HS) includes an e-mail API server and imaging server, and related caches and databases, as disclosed in U.S. patent application Ser. No. 11/774,106.

The publisher server 50 may also be programmed to function as a backbone server for facilitating electronic communications and placing tag lines or footers, that when activated direct the user's browsing application to a target web site or web page, as disclosed in U.S. patent application Ser. No. 11/774,106. Similarly, in this situation, the home server (HS) 30 includes an imaging server, a tag server, and related caches and databases, as disclosed in U.S. patent application Ser. No. 11/774,106.

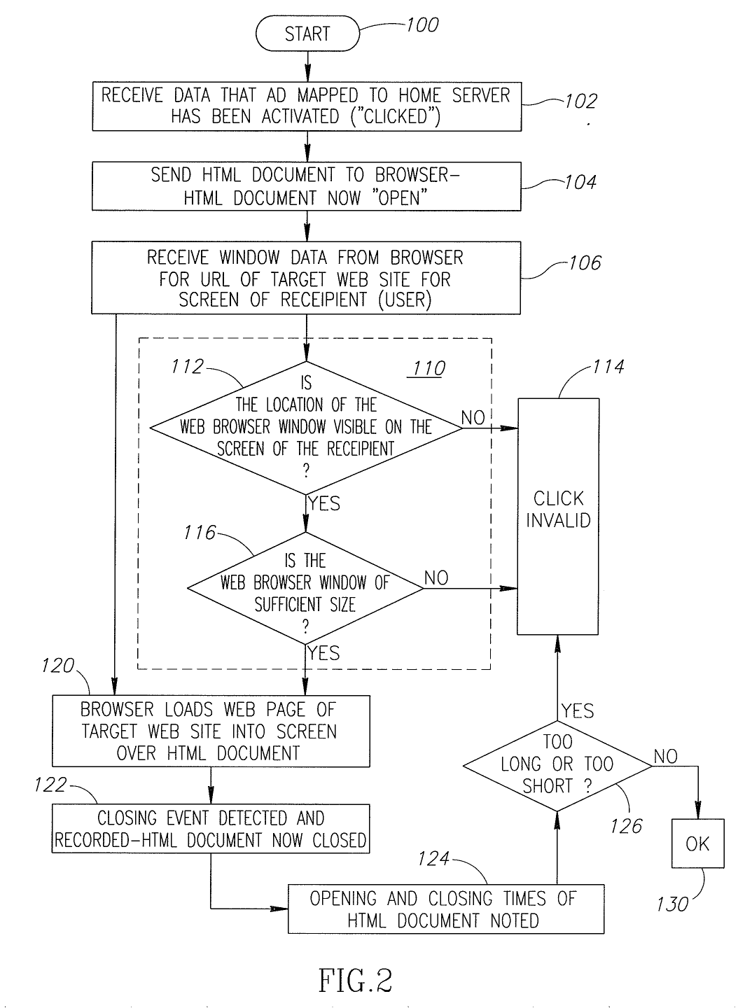

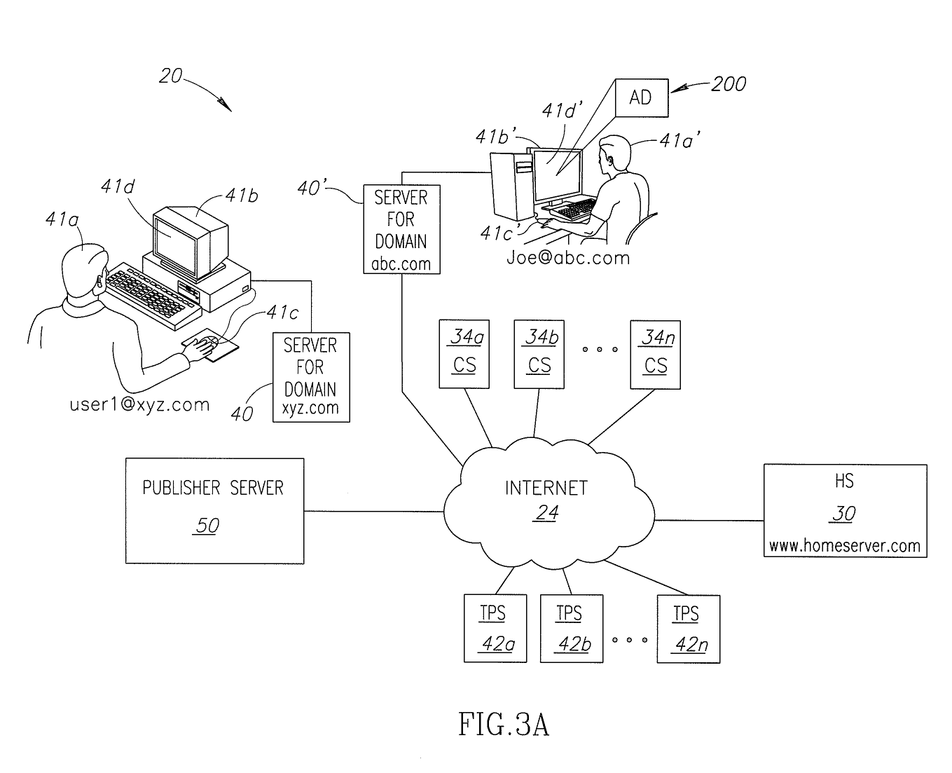

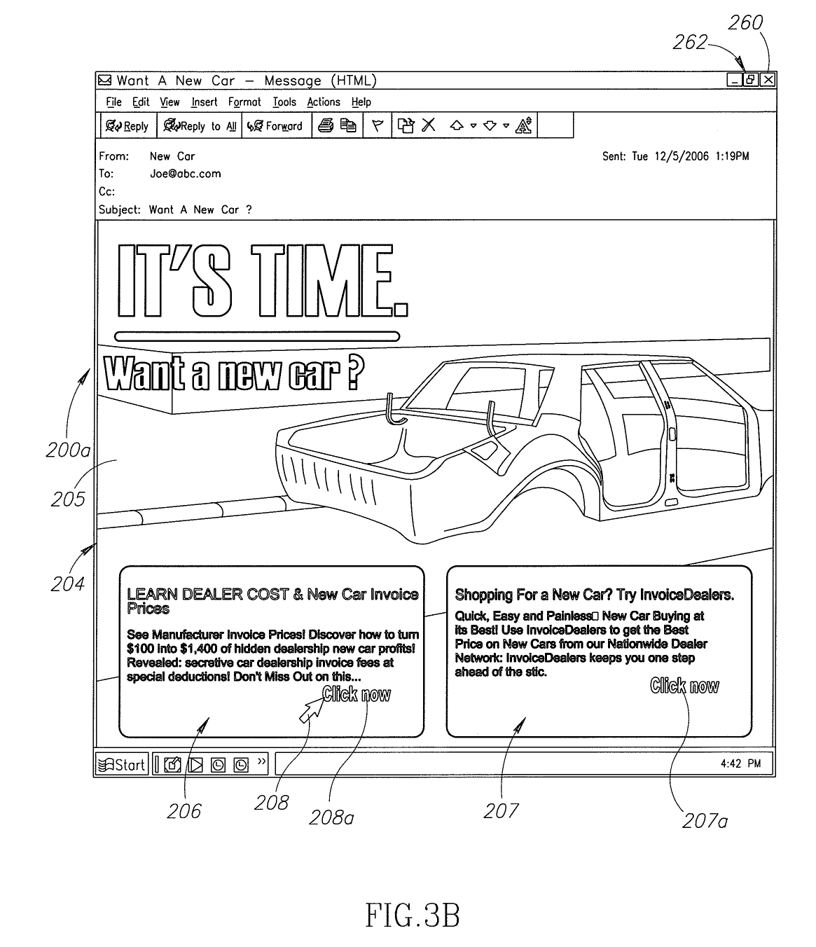

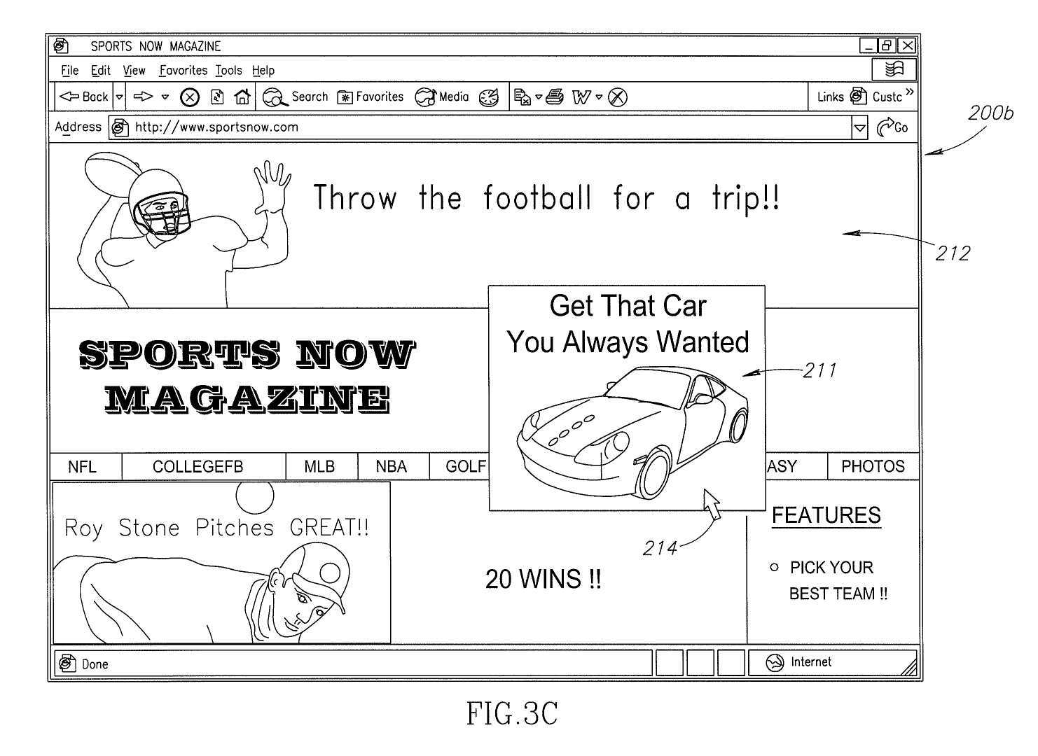

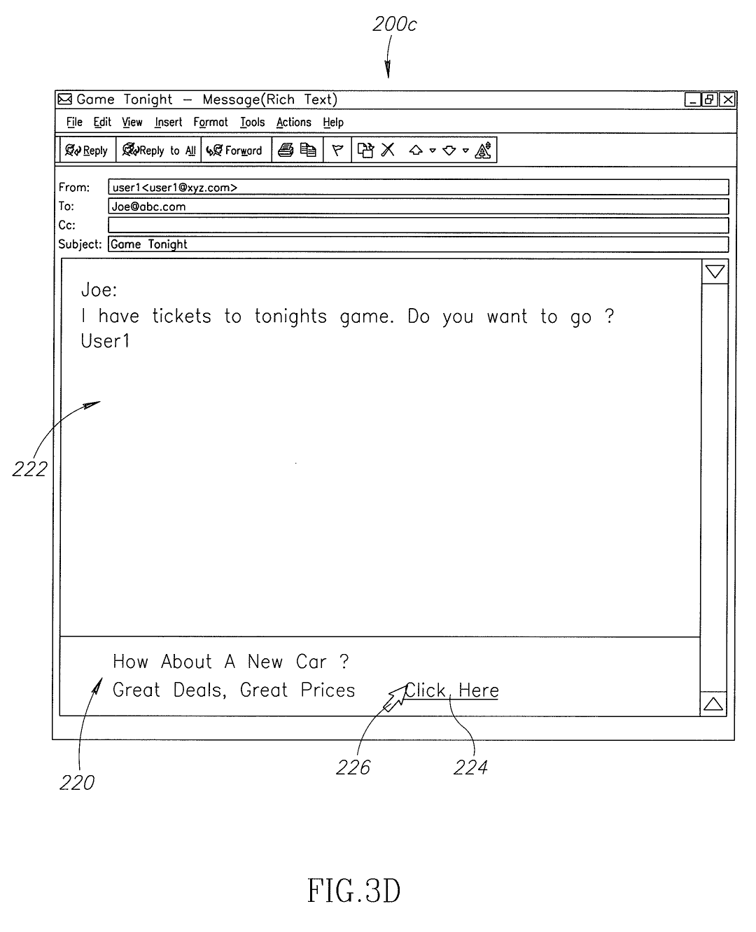

Attention is now directed to the flow diagram (flow chart) of FIG. 2, that details an exemplary processes in accordance with the disclosed subject matter. Attention is also directed to FIGS. 3A to 9B that illustrate various portions of the process of FIG. 2.

Prior to the start 100 of the process of FIG. 2, an exemplary user, for example the user 41a′, whose e-mail address is joe@abc.com, has received an electronic object, such as an electronic communication 200, for example, an advertising communication or AD, that appears on the monitor 41d′ of his computer 41b′, as shown in FIG. 3A. This electronic communication 200 is mapped back to the home server (HS) 30. When the electronic communication 200 is activated (by a click of the user's mouse 41c′, at for example, an activatable location on the electronic communication 200), will redirect the browser associated with his computer 41b′ to a URL of a target web site. For example, purposes, the URL for the target web site corresponds to a web site hosted by one of the third party server (TPS) 42a-42n of the system 20.

While these examples of electronic communications or content (creatives, banners, footers and tag lines), activatable to reach a target web site or web page associated with the home server (HS) 30 are shown, any other electronic communications, such as static e-mails, and the like are also suitable. Any web site or web page whose server is linked to the home server (HS) 30, for example, by being mapped back to the home server (HS) 30, for purposes of monitoring the web site or web page is also suitable for use with the disclosed subject matter. All of the aforementioned content, electronic communications, web sites and web pages, as well as any other media, programs or the like linked to a web page or web site, are collectively referred to as electronic object(s).

The electronic communication 200, indicated as an advertising communication (AD) may be, for example, in numerous forms. For example, the electronic communication 200a may be in the form of a creative (electronic communication with dynamically generated content) 204 in accordance with U.S. patent application Ser. Nos. 10/915,975 and 11/774,106, as shown in FIG. 3B. The creative or dynamic e-mail 204 includes a body 205, for example, of a static image and dynamic images 206, 207, that include activatable locations 206a, 207a (indicated by the words “Click now”), that when activated or click (as shown, for example, by the arrow 208), link to the home server (HS) 30, so as to be redirected to the URL of a target web site, also as detailed in U.S. patent application Ser. Nos. 10/915,975 and 11/774,106.

Another exemplary electronic communication 200b is a banner or the like, placed over a web page 212 being viewed, as shown in FIG. 3C. The banner 210 is in accordance with that disclosed in U.S. patent application Ser. No. 11/361,480, such that when activated or clicked on (as shown by the arrow 214) links to the home server 30, so that the user's browser is redirected to the URL of a target web site.

Another exemplary electronic communication 200c includes a footer 220 or tag line (collectively “footer”), or the like, placed into an e-mail 222 being viewed, as shown in FIG. 3D. The footer 220 includes a portion 224 that when activated or clicked on (as shown by the arrow 226) links to the home server 30, so that the user's browser is redirected to the URL of a target web site.

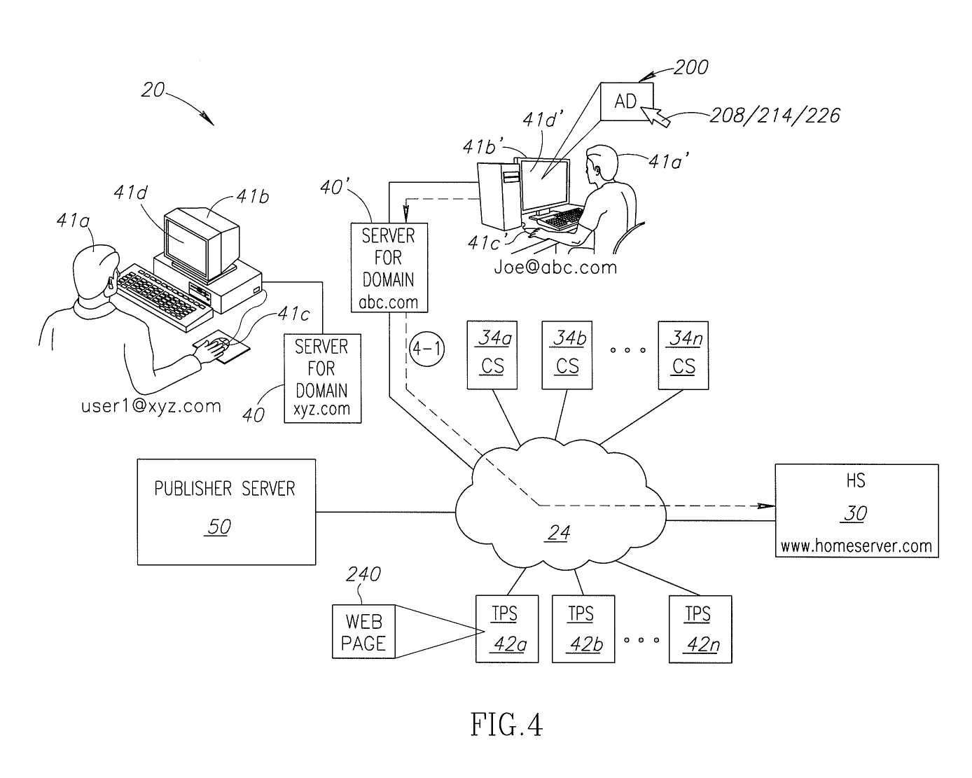

As shown in FIG. 4, once the electronic communications 200a-200c (represented by AD 200) are activated by clicks, arrows 208, 214, 226, a signal is sent to the home server (HS) 30 indicating this activation or click has been made. This signal is shown for example, as the broken line arrow 4-1 in FIG. 4. The web page, for example, the home page 240 of the target web site with the URL that the browsing application will be directed to, is shown, for example, as hosted by the third party server 42a. For example, the URL of the target web site here is www.ford.com, and the browsing application of the user 41a′ is directed to the corresponding target web site, hosted by the third party server 42a.

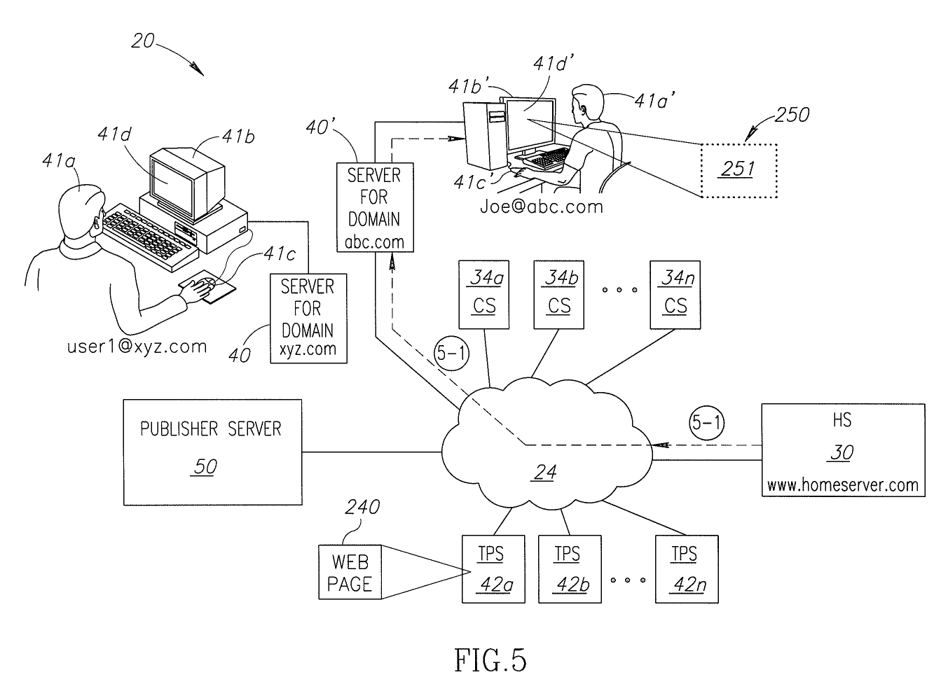

Returning also to FIG. 2, the home server (HS) 30 receives a signal, data or the like, indicating that the electronic communication 200 was activated by the requisite user, for example, the user 41a′, at block 102. The home server (HS) 30 sends (returns), to the browser or browsing application 250, associated with the user 41a′, a Hypertext Markup Language (HTML) code document 251, at block 104. This HTML document, for example, contains a single frame that instructs the browsing application 250 to use the click-through URL (to the target web site) as the only document view. It also contains java script code. As shown in FIG. 5, the sending of the HTML document 251 to the browsing application 250 by the home server (HS) 30 is shown by the broken line arrow 5-1.

The HTML document 251 permits a web page to be positioned within it. With the HTML document 251 now sent, once it reaches the user's computer 41b′ it is invisible to the user, for example, user 41a′, but is now considered to be open. The time the HTML document 251 is sent is recorded in the home server (HS) 30 as the time the HTML document 251 was opened in the browsing application 250.

The HTML document 251 includes java script or code that sends window size and position of the browser window for viewing the target web page of the target web site. The HTML document 251 also includes the “click” or redirect URL, the URL of the target web site associated with the clicked electronic communication 200, as part of a frame. The frame is an HTML command for the browsing application 250 to load a web page into the HTML document 251.

The HTML document 251, that includes the frame, the frame specified, for example, by the code segment:

<frameset>
<frame src=“CLICK-THROUGH URL”>
</frameset>

The frame may also be in accordance, for example, with the HTML standard, detailed in HTML 4.01 Specification-W3C Recommendation 24 Dec. 1999, Part 16 Frames, Sections 16.1 and 16.2, attached hereto as Appendix A. The browsing application 250 then renders the target website inside the HTML document 251. The resultant image, as seen by the user 41a′ on his computer monitor (screen) 41d′ is similar to that of viewing a typical web site. The HTML document 251 accommodates the web page 240, and is not affected by scroll ups, scroll downs, or other window size changes for the web page 240 made viewable by the browsing application 250 that overlies the HTML document.

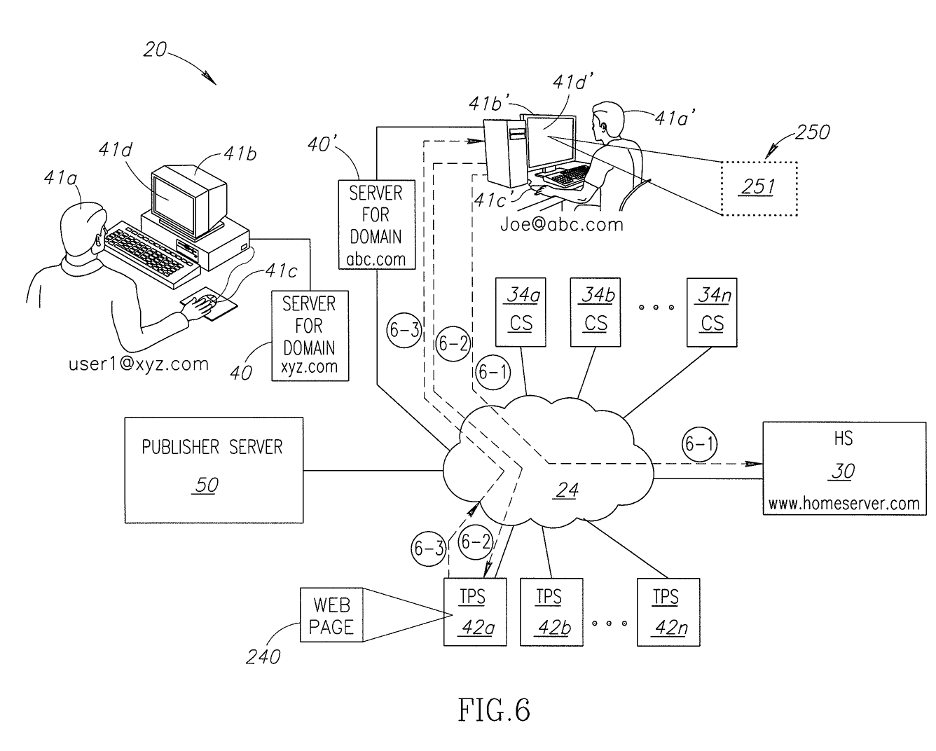

At block 106, the home server (HS) 30 receives window data for the screen (monitor) 41d′ of computer 41b′ of the user 41a′ from the browsing application (the browsing application contacts the home server (HS) 30 with the window data). This action is represented by the broken line arrow 6-1 in FIG. 6. The window data includes the size and position of the window that will be used in viewing the target web page.

In an optional step, the window data may be checked in order to determine if the click on the electronic communication was fraudulent (invalid or not valid). The process of determining this click fraud (click validity) is shown in the broken line box 110. Initially, at block 112, it is determined, whether the location of the web browser window is visible on the recipient's (user's) computer screen 41d′. If the web browser's window's location is not visible on the recipient's (user's) computer screen 41d′, the click is invalid, as per block 114. If the location of the screen data is on the recipient's (user's) screen 41d′, the process moves to block 116.

At block 116, it is determined if the web browser's window is of a sufficient size. This is typically a predetermined size, determined, for example, by the system administrator for the home server (HS) 30. For example, the predetermined size is such that a reasonable portion of the web page would be visible in the web browser's window. If the size is insufficient, the process moves to block 114, as the click is invalid. Alternately, if the size is sufficient, the process moves to block 120.

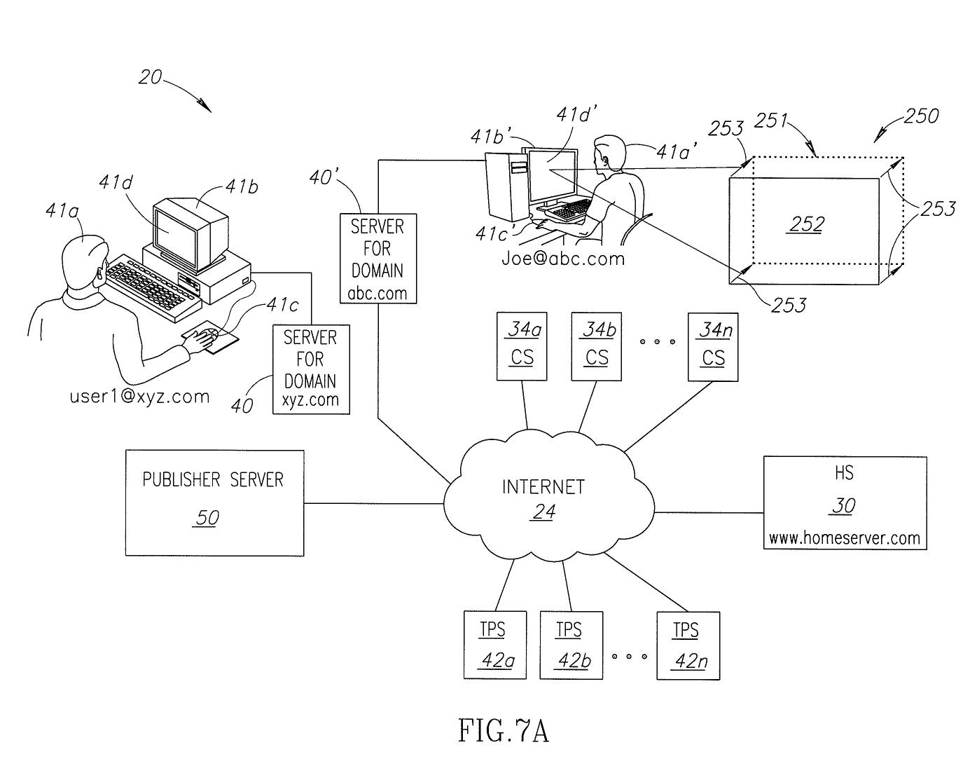

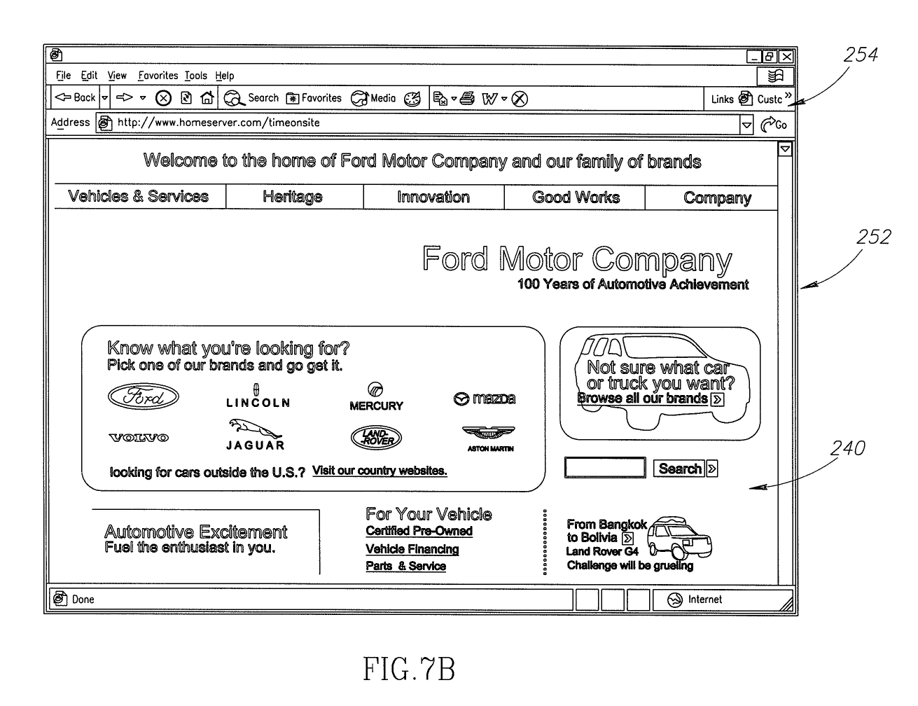

At block 120, the browser loads the web page 240 of the target web site over but within the HTML document 251 on the screen 41d′ of the computer 41b′ of the user 40a′. This sub-process typically involves two steps, illustrated in FIG. 6. The browser 250 obtains the URL of the target web site from the HTML document 251 and accesses the server that supports the target web site that has this target web page 240, as per broken line arrow 6-2. Next, the browser “pulls” the web page 240 from the third party server (TPS) 42a, as per the broken line arrow 6-3. As shown in FIG. 7A, the browser places the web page 240 (in a window 252) over the HTML document (shown by the arrows 253). The web page 240 is displayed in the window 252, the window 252 also including a header 254 (FIG. 7B).

The actual screen shot of the window 252 is shown in FIG. 7B. As shown in FIG. 7B, the web page 240 is, for example, the home page of the target web site (www.ford.com). The header 254 has the URL of the home server (HS) 30 that is monitoring the time the user is on (viewing) the requisite web site or web page, this URL for example, www.homeserver.com/timeonsite. Additionally, the web page 240 in the window 252 may change as the user activates different web pages within the same web site (target web site). The HTML document 251 remains open beneath the browser 250 during this movement between web pages of the same web site.

The event of block 106 and the event of block 120 may occur contemporaneous in time, and may be simultaneous. Although occurring at close timing, the events are independent of each other.

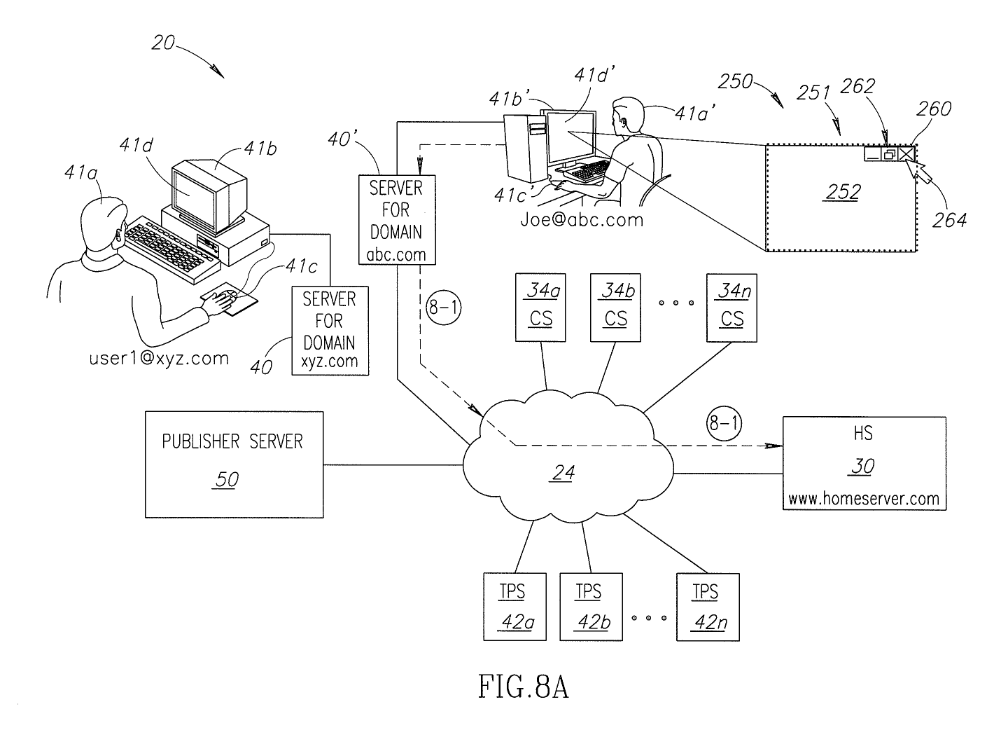

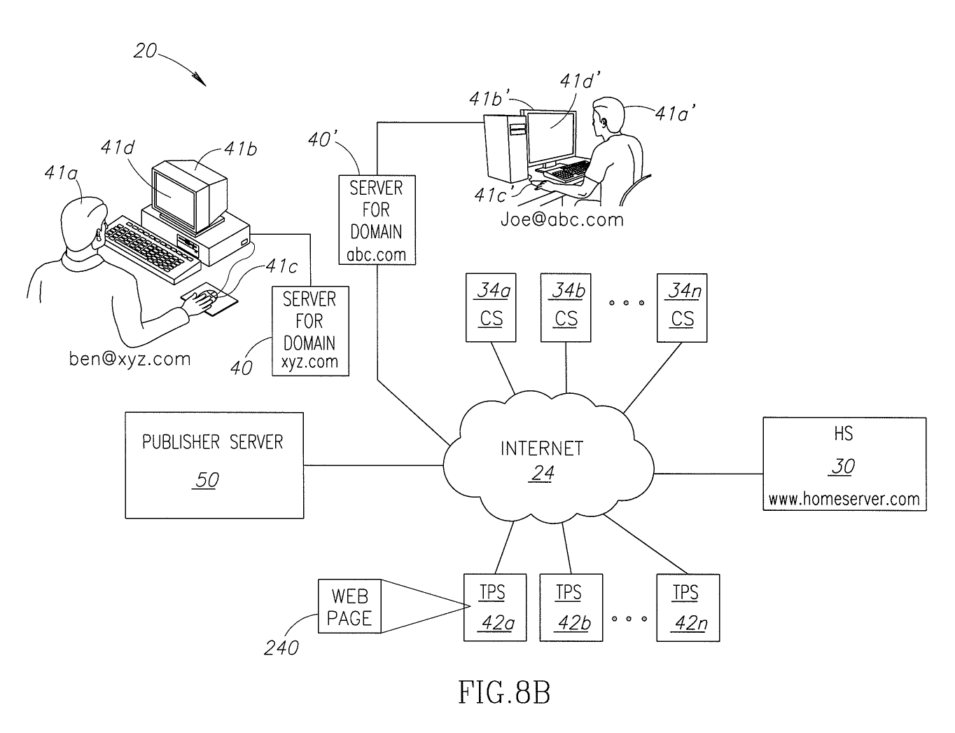

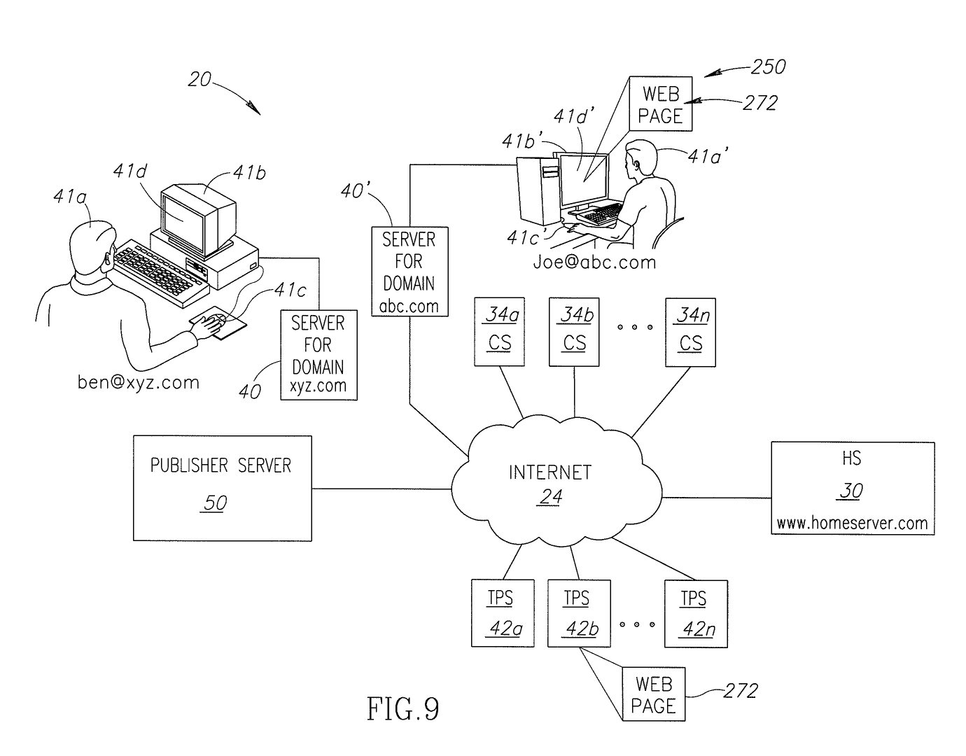

When there is a closing event, the closing of the HTML document 251 is detected and recorded by the home server (HS) 30, for example, by being signaled of the closing, as block 122. Closing events may include, for example, a closing of the web page (and accordingly, the web site) being viewed, as shown in FIGS. 8A and 8B, or a renavigation to another URL, as shown in FIG. 9. The closing time is recorded by the home server (HS) 30.

As shown in FIG. 8A, the closing event occurs as the “X” 260 of the on-screen controls 262, is activated or clicked on, as indicated by the arrow 264. The closing of the window 252, closes the HTML document 251 of the browser 250. A signal of this closing (shown by the broken line arrow 8-1) is sent to the home server (HS) 30. As a result of this frame closure, the HTML document 251 is no longer present on the monitor 41d′ of the user's computer 41b′, as shown in FIG. 8B.

Alternately, a closing event may occur as the result of a renavigation. For example, the present web page of the browser 250 is that corresponding to the URL ford.com. Should the user 41a′ decide to visit another page from a web site, for example, unaffiliated with the home server (HS) 30, such as www.funtravel.com, hosted, for example, by the third party server 42b, and represented by the web page 272 (FIG. 9). Once the browser is redirected to the URL www.funtravel.com, the HTML document 251 closes. This closure and its time is recorded in the home server (HS) 30.

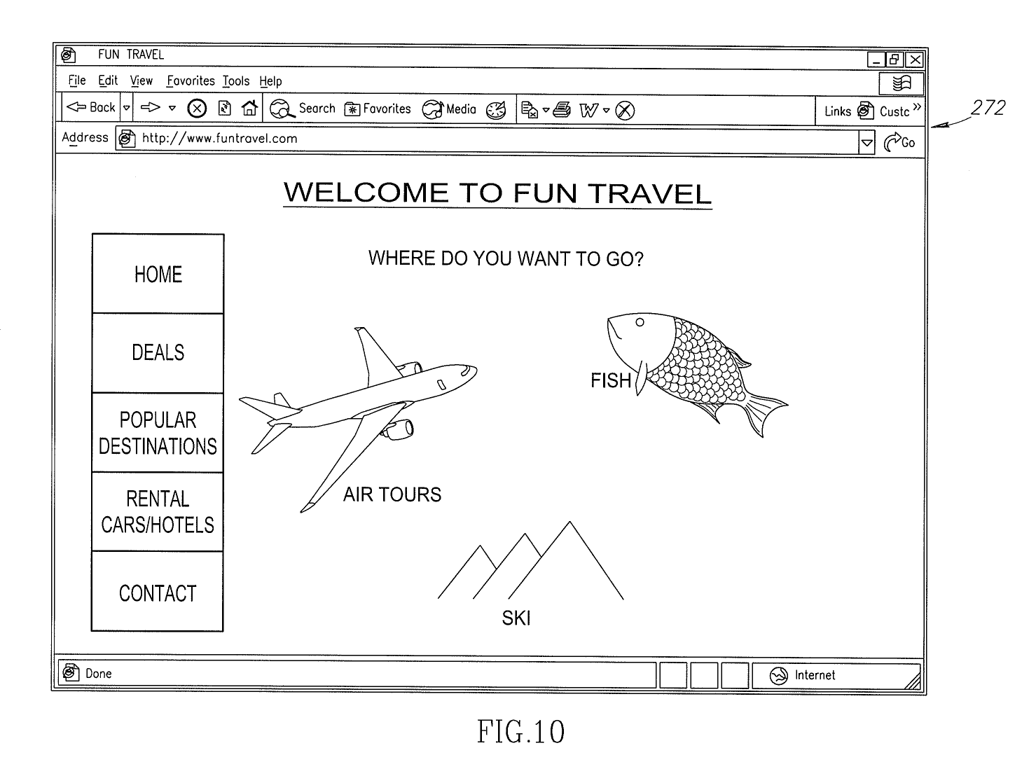

A new web page 272 with the URL www.funtravel.com has replaced the web page 240 in the browser 250 associated with the user 40a′, as shown by the screen diagram of FIG. 10. However, an underlying HTML document 251 (FIGS. 6, 7A and 8A) and header 254 (FIG. 7B) is not present with this new web page 272, as, for example, this URL and/or server 42b is not associated with the home server (HS) 30 (and is not monitored by the home server (HS) 30 or any other device associated with the home server (HS) 30).

The web browser may be closed by other methods, such as use of a hot key or menu option, or any other known method for moving to a new web site or web page. Resuming the process from block 122, the process moves to block 124, where the opening and closing times of the HTML document 251 are again noted. It is then determined, if the time (time period) between the HTML document 251 opening and closing was too long or two short, and hence, outside of a predetermined time period, at block 126. The predetermined time period is, for example, determined by the system administrator or the like and is typically programmed into the home server (HS) 30. If outside of the predetermined time period, the process moves to block 114.

At block 114, it is determined that the click (that resulted in the click-through to the target web site) was fraudulent (not valid), as detailed above. Otherwise, if within the predetermined time period, the process moves to block 130. At block 130, the click, that resulted in the click-through to the target web site, is considered legitimate (valid), and accordingly, validating any revenues associated with the click, that resulted in the browsing application arriving at the URL of the target web site.

The above-described processes including portions thereof can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer-usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for monitoring the time a user spends on a web site comprising:
sending a document to the browsing application associated with a user who has activated the browsing application to be directed to a target web site;
recording the time the document is sent;
receiving a web page corresponding to the target web site in the browsing application for overlying the document;
closing the document in response to a closing event of the web site in the browsing application; and
recording the time the document was closed.

2. The method of claim 1, additionally comprising:
receiving data that an electronic object has been activated; and
wherein the sending a document to the browsing application is in response to receiving the data that an electronic object has been activated.

3. The method of claim 1, wherein the document includes a hypertext mark up language (HTML) coded document.

4. The method of claim 3, additionally comprising receiving window data for the screen of computer associated with the user and the browsing application from the browsing application.

5. The method of claim 4, wherein the window data includes the size and position of the window that will be used in viewing the target web page.

6. The method of claim 3, wherein the HTML coded document accommodates movement of the web page being viewed by the user.

7. The method of claim 1, wherein the closing event is selected from the group consisting of a closing of the web page being viewed and a renavigation to a different uniform resource locator.

8. The method of claim 2, wherein the electronic object is selected from the group consisting of electronic communications, web sites and web pages.

9. A method for determining the validity of a click comprising;
receiving an indication of a click on an electronic object;
sending a document to the browsing application associated with a user who has activated the browsing application to be directed to a target web site;
recording the time the document is sent;
receiving a web page corresponding to the target web site in the browsing application for overlying the document;
closing the document in response to a closing event of the web site in the browsing application;
recording the time the document was closed; and,
determining from the recorded times if the click is valid.

10. The method of claim 9, wherein determining from the recorded times if the click was valid includes, determining if the recorded time was at least a predetermined length, and if not at least a predetermined length, the click is not valid.

11. The method of claim 9, wherein the document includes a hypertext mark up language (HTML) coded document.

12. The method of claim 11, additionally comprising receiving window data for the screen of computer associated with the user and the browsing application from the browsing application.

13. The method of claim 12, wherein the window data includes the size and position of the window that will be used in viewing the target web page.

14. The method of claim 11, wherein the HTML coded document accommodates movement of the web page being viewed by the user.

15. The method of claim 9, wherein the closing event is selected from the group consisting of a closing of the web page being viewed and a renavigation to a different uniform resource locator.

16. The method of claim 9, wherein the electronic object is selected from the group consisting of electronic communications, web sites and web pages.

17. A system for monitoring the time a user spends on a web site comprising:
a component for providing a document; and,
a processor programmed to:
send a document to the browsing application associated with a user who has activated the browsing application to be directed to a target web site;
record the time the document is sent;
receive a web page corresponding to the target web site in the browsing application for overlying the document;
close the document in response to a closing event of the web site in the browsing application; and
record the time the document was closed.

18. The system of claim 17, wherein the processor is additionally programmed to:
receive data that an electronic object has been activated; and
respond to the received data by sending the document to the browsing application.

19. The system of claim 17, wherein the component for providing a document is configured for providing a hypertext mark up language (HTML) coded document, the HTML coded document for accommodating movement of the web page being viewed by the user.

20. The system of claim 19, wherein the processor is additionally programmed to receive window data for the screen of computer associated with the user and the browsing application from the browsing application, the window data including the size and position of the window that will be used in viewing the target web page.

21. The system of claim 19, wherein the component for providing a document includes a storage device.

22. The system of claim 19, wherein the component for providing a document includes a component for generating the document.

23. A system for determining the validity of a click comprising:
a component for providing a document; and,
a processor programmed to:
receive an indication of a click on an electronic object;
send a document to the browsing application associated with a user who has activated the browsing application to be directed to a target web site;
record the time the document is sent;
receive a web page corresponding to the target web site in the browsing application for overlying the document;
close the document in response to a closing event of the web site in the browsing application;
record the time the document was closed; and
determine from the recorded times if the click is valid.

24. The system of claim 23, wherein the processor is additionally programmed to:
determine from the recorded times if the click was valid by determining if the recorded time was at least a predetermined length, and if not at least a predetermined length, the click is not valid.

25. The system of claim 23, wherein the component for providing a document is configured for providing a hypertext mark up language (HTML) coded document, the HTML coded document for accommodating movement of the web page being viewed by the user.

26. The system of claim 25, wherein the processor is additionally programmed to receive window data for the screen of computer associated with the user and the browsing application from the browsing application, the window data including the size and position of the window that will be used in viewing the target web page.

27. The system of claim 23, wherein the component for providing a document includes a storage device.

28. The system of claim 23, wherein the component for providing a document includes a component for generating the document.

29. A computer-usable storage medium having a computer program embodied thereon for causing a suitably programmed system to monitor the time a user spends on a web site, by performing the following steps when such program is executed on the system:
sending a document to the browsing application associated with a user who has activated the browsing application to be directed to a target web site;
recording the time the document is sent;
receiving a web page corresponding to the target web site in the browsing application for overlying the document;
closing the document in response to a closing event of the web site in the browsing application; and
recording the time the document was closed.

30. The computer-usable storage medium of claim 29, additionally for performing the following steps when the program is executed on the system:
receiving data that an electronic object has been activated and responding to the received data by sending the document to the browsing application.

31. The computer-usable storage medium of claim 29, wherein the document includes a hypertext mark up language (HTML) coded document.

32. The computer-usable storage medium of claim 29, additionally for performing the following steps when the program is executed on the system:
receiving window data for the screen of computer associated with the user and the browsing application from the browsing application.

33. The computer-usable storage medium of claim 32, wherein the window data includes the size and position of the window that will be used in viewing the target web page.

34. The computer-usable storage medium of claim 29, wherein the HTML coded document accommodates movement of the web page being viewed by the user.

35. The computer-usable storage medium of claim 29, wherein the closing event is selected from the group consisting of a closing of the web page being viewed and a renavigation to a different uniform resource locator.

36. The computer-usable storage medium of claim 30, wherein the electronic object is selected from the group consisting of electronic communications, web sites and web pages.

37. A computer-usable storage medium having a computer program embodied thereon for causing a suitably programmed system to determine the validity of a click, by performing the following steps when such program is executed on the system:
receiving an indication of a click on an electronic object;
sending a document to the browsing application associated with a user who has activated the browsing application to be directed to a target web site;
recording the time the document is sent;
receiving a web page corresponding to the target web site in the browsing application for overlying the document;
closing the document in response to a closing event of the web site in the browsing application;
recording the time the document was closed; and,
determining from the recorded times if the click is valid.

38. The computer-usable storage medium of claim 37, wherein determining from the recorded times if the click was valid includes, determining if the recorded time was at least a predetermined length, and if not at least a predetermined length, the click is not valid.

39. The computer-usable storage medium of claim 37, wherein the document includes a hypertext mark up language (HTML) coded document.

40. The computer-usable storage medium of claim 37, additionally for performing the following steps when the program is executed on the system:
receiving window data for the screen of computer associated with the user and the browsing application from the browsing application.

41. The computer-usable storage medium of claim 40, wherein the window data includes the size and position of the window that will be used in viewing the target web page.

42. The computer-usable storage medium of claim 39, wherein the HTML coded document accommodates movement of the web page being viewed by the user.

43. The computer-usable storage medium of claim 37, wherein the closing event is selected from the group consisting of a closing of the web page being viewed and a renavigation to a different uniform resource locator.

44. The computer-usable storage medium of claim 37, wherein the electronic object is selected from the group consisting of electronic communications, web sites and web pages.

45. A method for determining the validity of a click, comprising:
receiving an indication of a click on an activatable location of an electronic object; and
determining if the location of the web browser window that supported the activatable location is visible on the screen of the user associated with the click.

46. The method of claim 45, additionally comprising determining if the web browser window is at least a predetermined size.

47. The method of claim 45, wherein the click is considered not valid if the location of the web browser window that supported the activatable location is not visible on the screen of the user associated with the click.

48. The method of claim 47, wherein the click is considered not valid if the web browser window is less than the predetermined size.

49. A system for determining the validity of a click comprising:
a first component configured for receiving an indication of a click on an activatable location of an electronic object; and
a second component configured for determining if the location of the web browser window that supported the activatable location is visible on the screen of the user associated with the click.

50. The system of claim 49, additionally comprising:
a third component configured for determining if the web browser window is at least a predetermined size.

51. The system of claim 49, additionally comprising:
a third component for determining the click is not valid if the location of the web browser window that supported the activatable location is not visible on the screen of the user associated with the click.

52. The system of claim 50, additionally comprising:
a fourth component for determining the click is not valid if the web browser window is not at least a predetermined size.

53. A computer-usable storage medium having a computer program embodied thereon for causing a suitably programmed system to determine the validity of a click, by performing the following steps when such program is executed on the system:
receiving an indication of a click on an activatable location of an electronic object; and
determining if the location of the web browser window that supported the activatable location is visible on the screen of the user associated with the click.

54. The computer-usable storage medium of claim 53, additionally for performing the following steps when the program is executed on the system:
determining if the web browser window is at least a predetermined size.

55. The computer-usable storage medium of claim 53, additionally for performing the following steps when the program is executed on the system:
determining the click is not valid if the location of the web browser window that supported the activatable location is not visible on the screen of the user associated with the click.

56. The computer-usable storage medium of claim 54, additionally for performing the following steps when the program is executed on the system:
determining the click is not valid if the web browser window is less than the predetermined size.
